(19) United States
(12) Patent Application Publication
(10) Pub. No.: US 2026/0091976 A1
(43) Pub. Date: Apr. 2, 2026

(54) THERMOCHEMICAL GAS SPLITTING REACTOR SYSTEM AND METHOD OF THERMOCHEMICALLY SPLITTING GAS

(71) Applicant: The Regents of the University of Colorado, a body corporate, Denver, CO (US)

(72) Inventors: Justin T. TRAN, Broomfield, CO (US); Kent J. WARREN, Broomfield, CO (US); Alan W. WEIMER, Niwot, CO (US); Robert L. ANDERSON, Boulder, CO (US); Dragan MEJIC, Brighton, CO (US)

(21) Appl. No.: 19/112,906

(22) PCT Filed: Sep. 26, 2023
(86) PCT No.: PCT/US2023/033759

§ 371 Date: Mar. 18, 2025

Related U.S. Application Data
(60) Provisional application No. 63/410,177, filed on Sep. 26, 2022.
(60) Provisional application No. 63/425,617, filed on Nov. 15, 2022.

(51) Int. Cl. C01B 3/061; B01J 3/00; B01J 8/18; B01J 8/34

(52) U.S. Cl. CPC C01B 3/061; B01J 3/006; B01J 8/1836; B01J 8/34; B01J 2208/00398; B01J 2208/00415; B01J 2208/0053

(57) ABSTRACT

A thermochemical gas splitting reactor system and a method of splitting gas are disclosed. The system includes a reactor including a reaction zone comprising active material, a gas heating zone, and a gas distribution plate assembly interposed between the reaction zone and the gas heating zone. Exemplary systems can include multiple reactors. The method can include providing one or more reactors and performing one or more of an oxidation and/or reduction process using each of the reactors.

### CROSS-REFERENCE TO RELATED APPLICATIONS

This application claims priority to U.S. Provisional Application No. 63/410,177, entitled “PRESSURE SWING REDOX PROCESSING TO SPLIT H₂O/CO₂,” and filed Sep. 26, 2022, and U.S. Provisional Application No. 63/425,617, entitled “PRESSURE SWING REDOX PROCESSING TO SPLIT H₂O/CO₂,” and filed Nov. 15, 2022, the contents of which are hereby incorporated herein by reference.

### STATEMENT REGARDING FEDERALLY-SPONSORED RESEARCH OR DEVELOPMENT

This invention was made with government support under grant number DGE1650115 awarded by the National Science Foundation. The government has certain rights in the invention.

### FIELD OF THE DISCLOSURE

The present disclosure generally relates to thermochemical gas splitting reactor systems and to methods of splitting gas, such as one or more of H₂O and CO₂.

### BACKGROUND OF THE DISCLOSURE

The use of hydrogen as a renewable fuel has been stymied by an inability to produce hydrogen cleanly and economically. Conventional solar thermochemical approaches consider a two-step redox cycle with benchmark ceria or a perovskite in a temperature swing configuration, where reduction occurs at a temperature much higher than oxidation. Isothermal redox cycling is feasible and avoids the solid-solid heat recuperation and material stability challenges associated with large temperature swings; yet, it has long been thought to be inefficient due to the thermodynamic unfavourability of operating the exothermic oxidation reaction at higher temperatures.

Further, two-step thermochemical processes for dissociation of H₂O and/or CO₂ (e.g., via solar heat) have historically performed the oxidation (fuel producing) step at ambient pressure, and as a result, in practice, work required for product compression is significant. Accordingly, improved methods and systems suitable for splitting water (and/or carbon dioxide) in a relatively efficient manner are desirable.

Any discussion, including discussion of problems and solutions, set forth in this section has been included in this disclosure solely for the purpose of providing a context for the present disclosure. Such discussion should not be taken as an admission that any or all of the information was known at the time the invention was made or otherwise constitutes prior art.

### SUMMARY OF THE DISCLOSURE

This summary is provided to introduce a selection of concepts. This summary is not intended to necessarily identify key features or essential features of the claimed subject matter, nor is it intended to be used to limit the scope of the claimed subject matter.

In accordance with examples of the disclosure, a thermochemical gas splitting reactor system and a method of splitting gas are provided. The system and method can be used to, for example, split water vapor (H₂O) and/or carbon dioxide (CO₂) in a relatively energy-efficient and cost-effective manner.

In accordance with exemplary embodiments of the disclosure, a thermochemical gas splitting reactor system includes a reactor that includes a reaction zone, a gas heating zone, and a gas distribution plate assembly interposed between the reaction zone and the gas heating zone. The thermochemical gas splitting reactor system also includes a gas inlet fluidly coupled to the gas heating zone, a gas outlet fluidly coupled to the reaction zone, and a controller configured to operate the reaction zone at a temperature greater than about 1000° C., and to control a pressure within the reaction zone or chamber to greater than 1 bar during a gas splitting step and less than or equal to 1 bar during an active material reduction step. In accordance with aspects of these embodiments, a system includes multiple reactors that can operate in reduction and/or oxidation mode, to allow continuous operation and removal of products from the system. In accordance with further aspects, the reactor and/or the system operates substantially isothermally. The reaction zone can include active material. In accordance with further aspects, the reactor comprises an insulated wall contained within a pressure vessel. The gas distribution plate can be formed of one or more ceramic structures comprising alumina, zirconia, and/or silica. In accordance with further aspects, the gas distribution plate is configured to facilitate or allow flow substantially along an (e.g., vertical) axis of the reactor. In accordance with yet further aspects, the system can include one or more heaters or heat sources to heat or preheat gas entering the reactor.

In accordance with additional embodiments of the disclosure, a method of thermochemically splitting gas is provided. As above, the gas to be split can be or include, for example, steam and/or carbon dioxide. The method includes providing a reactor (e.g., a reactor as described above or elsewhere herein), providing a gas to the reactor (e.g., one or more of H₂O and CO₂) to the gas heating zone, heating the gas (e.g., one or more of H₂O and CO₂) in the gas heating zone, providing heated gas (e.g., one or more of H₂O and CO₂) through the gas distribution plate assembly and to the reaction zone, and splitting the heated gas (e.g., one or more of H₂O and CO₂) in the reaction zone, wherein a temperature within the reaction zone is greater than about 1000° C. and pressure within the reaction zone is greater than 1 bar. The method can further include performing an active material reduction step. A pressure within the reaction zone or chamber during the active material reduction step can be controlled to less than or equal to 1 bar. The method can include continually removing product gas from the reaction zone during the step of splitting and/or during a step of performing an active material reduction step. Exemplary methods can further include heating gas prior to the gas entering the reaction zone and/or prior to entering the reactor.

These and other embodiments will become readily apparent to those skilled in the art from the following detailed description of certain embodiments having reference to the figures; the disclosure not being limited to any particular embodiment(s) disclosed.

### BRIEF DESCRIPTION OF DRAWINGS

A more complete understanding of the embodiments of the present disclosure may be derived by referring to the detailed description and claims when considered in connection with the following illustrative figures.

FIG. 1 illustrates a thermochemical gas splitting reactor system in accordance with at least one embodiment of the disclosure.

FIG. 2 illustrates another thermochemical gas splitting reactor system in accordance with at least one embodiment of the disclosure.

FIG. 3 illustrates a multiple reactor system in accordance with at least one embodiment of the disclosure.

FIG. 4 illustrates a gas distribution plate assembly in accordance with at least one embodiment of the disclosure.

FIG. 5 illustrates a gas distribution plate assembly in accordance with another embodiment of the disclosure.

FIG. 6 illustrates thermochemical cycling of two candidate active materials in accordance with examples of the disclosure.

FIG. 7 illustrates a cumulative amount of CO production in accordance with examples of the disclosure.

FIG. 8 illustrates peak rate of production after accounting for the effects of gas-phase dispersion and mixing in accordance with examples of the disclosure.

FIG. 9 illustrates equilibrium oxygen content of undoped ceria, CeO_{2-δ}, and the iron aluminate Fe33Al67, (Fe_{1/3}Al_{2/3})_{3-δ}O₄, as a function of oxygen partial pressure at 1400° C. in accordance with examples of the disclosure.

FIG. 10 illustrates a measured extent of Fe33Al67 oxidation as a function of inlet oxidant composition (i.e., CO₂:CO ratio) and pressure at 1400° C., where each corresponding oxygen partial pressure, determined according to the equilibrium of carbon dioxide thermolysis, is presented in the top panel.

It will be appreciated that elements in the figures are illustrated for simplicity and clarity and have not necessarily been drawn to scale. For example, the dimensions of some of the elements in the figures may be exaggerated relative to other elements to help improve understanding of illustrated embodiments of the present disclosure.

### DETAILED DESCRIPTION OF EXEMPLARY EMBODIMENTS OF THE DISCLOSURE

Although certain embodiments and examples are disclosed below, it will be understood that the invention extends beyond the specifically disclosed embodiments and/or uses thereof and obvious modifications and equivalents thereof. Thus, it is intended that the scope of the invention disclosed should not be limited by the particular disclosed embodiments described below.

The present disclosure provides an improved method and a system for splitting gas-phase reactants using reduction and oxidation (redox) reactions. As set forth in more detail below, in some cases, the method and system can be operated under substantially isothermal conditions or within specified temperature swings to provide desired energy and/or cost efficiency, while providing desired product throughput.

In this disclosure, substantially isothermally can mean that a temperature during reduction phase and a temperature during oxidation phase of reduction and oxidation cycle or process are within ±10° C. or ±25° C. or ±50° C. or ±100° C. or +150° C. of each other during operation.

In this disclosure, gas can include material that is a gas at normal temperature and pressure, a vaporized solid and/or a vaporized liquid, and may be constituted by a single gas or a mixture of gases, depending on the context. An inert gas can be a gas that does not take part in a chemical reaction to an appreciable extent. An exemplary inert gas includes nitrogen.

In this disclosure, continuously or continuous or continually can refer to without interruption as a timeline, without any material intervening step, without changing process conditions, or immediately thereafter, as a next step, depending on the context.

In this disclosure, any two numbers of a variable can constitute a workable range of the variable, and any ranges indicated can include or exclude the endpoints. Additionally, any values of variables indicated (regardless of whether they are indicated with “about” or not) may refer to precise values or approximate values and include equivalents, and may refer to average, median, representative, majority, etc. in some embodiments. Further, in this disclosure, the terms “including,” “constituted by” and “having” and variations thereof can refer independently to “typically or broadly comprising,” “comprising,” “consisting essentially of,” or “consisting of” and variations thereof in some embodiments. In accordance with aspects of the disclosure, any defined meanings of terms do not necessarily exclude ordinary and customary meanings of the terms.

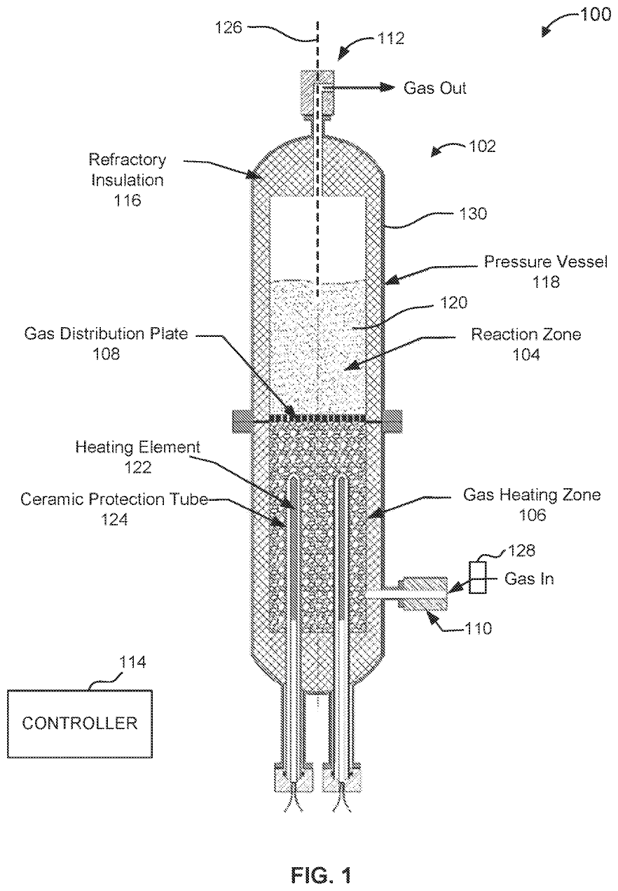

Turning now to the figures, FIG. 1 illustrates a thermochemical gas splitting reactor system 100 in accordance with examples of the disclosure. Thermochemical gas splitting reactor system 100 includes a reactor 102, which includes a reaction zone 104, a gas heating zone 106, and a gas distribution plate assembly 108 interposed between reaction zone 104 and the gas heating zone 106; a gas inlet 110 fluidly coupled to gas heating zone 106; a gas outlet 112 fluidly coupled to reaction zone 104; and a controller 114.

Reactor 102 can be configured to operate at a temperature during reduction phase and/or during oxidation phase greater than 800° C. or greater than 1000° C. or between about 800° C. and about 1500° C. or between about 900° C. and about 1400° C. In some cases, the reduction and oxidation phases can be within about +400° C. of each other or within about ±300° or within about ±200° or can be operated substantially isothermally.

As illustrated, reaction zone 104 includes active material 120. Active material 120 includes material that is reduced during a reduction phase or process and is oxidized during an oxidation phase or process. In accordance with examples of the disclosure, active material 120 comprises a metal oxide. For example, active material 120 can be or include iron aluminate-based spinels (e.g., Fe33Al67), lanthanum-manganate-based perovskites (e.g., LSMA6464, and/or ceria-based oxides (e.g., Ce_{0.80}Zr_{0.20}O_{2-δ}). In some cases, active material 120 comprises (M_{ζ}Al_{1-ζ})_{3-δ}O₄, where Z is greater than ⅓ and M is one or more of Fe, Co, Ti, Mn, Mg, Zn, Ni, and Cr. By way of one example, active material 120 can be or include CoₓFe_{1-x+y}Al_{2-y}O₄, wherein x is between 0 and 0.4 or 0.4 and 1.0 and y is between 0 and 0.4 or 0.4 and 1.

Reaction zone 104 can be configured as a fluidized bed reactor or as a packed bed reactor. Accordingly, active material 120 can be packed or fluidized during operation of 20) reactor 102.

Gas heating zone 106 can include one or more heat sources or elements 122 to heat gas within gas heating zone 106—e.g., gas received from gas inlet 110—prior to the gas entering reaction zone 104. Heat sources or elements 122 can be or include, for example, a concentrated solar radiation heater, a heat exchanger (e.g., wherein a gas within the gas heating zone is heated using the heat exchanger and optionally the heat exchanger removes heat from a product gas that is removed from the reactor via the gas outlet), one or more (e.g., an array of) resistive heaters, or the like. In some cases, a ceramic protection tube 124 (e.g., formed of one or more of alumina, zirconia, silicon carbide, boron nitride, silicon nitride) can be used to protect heating element 122. The array of resistive heaters can include from about 2 to about 10 or about 10 to about 50 resistive heaters.

Gas distribution plate assembly 108 can be used to support fluidized and/or packed bed particles, such as material 120. Additionally, gas distribution plate assembly 108 can be configured to facilitate and promote flow of gas in a direction along an (e.g., vertical) axis 126 between gas heating zone 106 and reaction zone 104. In accordance with examples of the disclosure, gas distribution plate assembly 108 includes one or more ceramic structures comprising a refractory material, such as one or more of alumina, zirconia, and/or silica. As discussed in more detail below, gas distribution plate assembly 108 can include a plurality of holes having a cross-sectional diameter between about 2.5 mm and about 0.5 mm and/or between about 200 microns and about 1 micron.

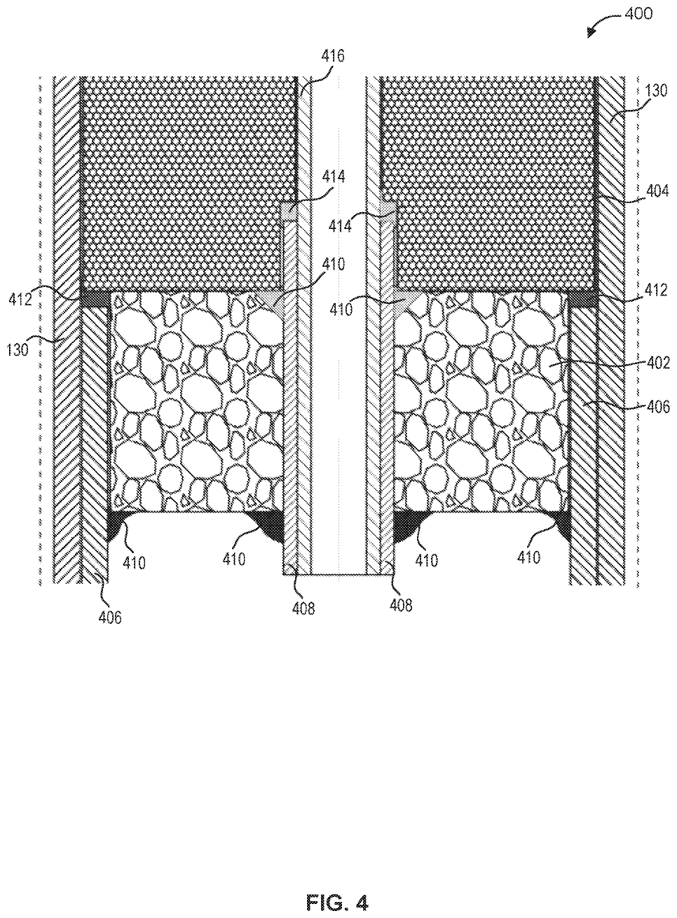

FIG. 4 illustrates a gas distribution plate assembly 400 suitable for use as gas distribution plate assembly 108 in accordance with examples of the disclosure. Gas distribution plate assembly 400 includes porous ceramic frit and a plate 404. Porous ceramic frit 402 can be formed of, for example, zirconia or the like. Porous ceramic frit 402 can include an average pore size of about 2.5 mm to about 0.5 mm or about 0.5 mm to about 0.1 mm. A porosity of ceramic frit 402 can be between about 10 PPI (pores per inch) and about 45 PPI or between about 45 PPI and about 250 PPI. Plate 404 can be formed of, for example alumina, zirconia or the like. Plate 404 can include holes, having an average diameter or cross-section of about 200 microns to about 1 micron or about 40 microns to about 1 micron.

As illustrated, ceramic frit 402 can be adhered to one or more liners 406, 408 using an adhesive 410. Liners 406, 408 can be formed of, for example, alumina, zirconia, or the like. Adhesive 410 can be or include, for example, a ceramic adhesive, such as alumina. Liner 406 can be adhered to plate 404 and/or wall 130 using an adhesive 412, which can be the same or similar to adhesive 410. Liner 408 can similarly be adhered to plate 404 and an inlet tube 416 (not separately illustrated in FIG. 1) using an adhesive 414, which can be the same or similar to adhesive 410.

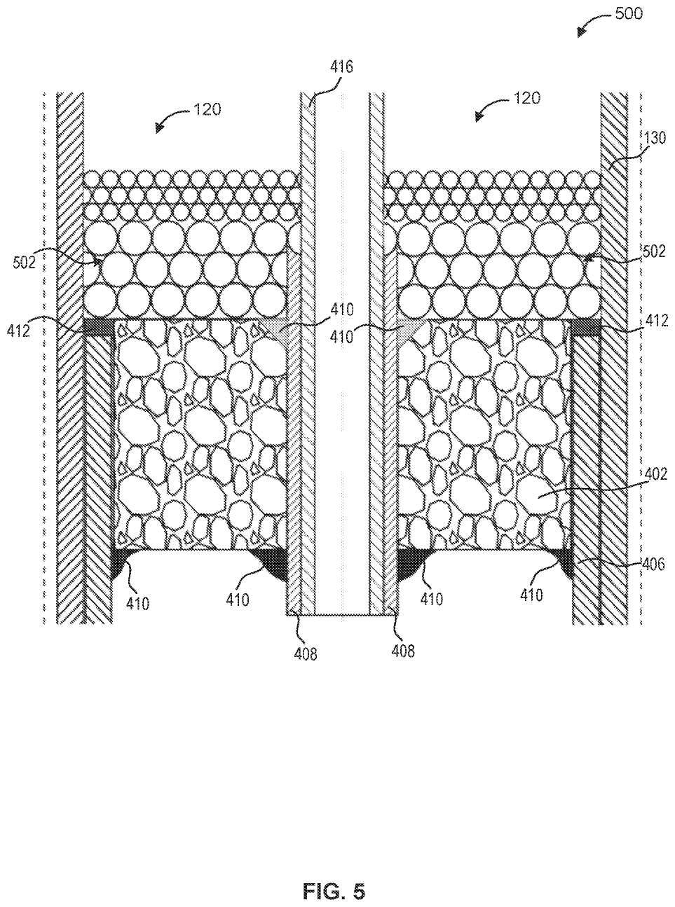

FIG. 5 illustrates another gas distribution plate assembly 500 suitable for use as gas distribution plate assembly 108 in accordance with examples of the disclosure. Gas distribution plate assembly 500 is similar to gas distribution plate assembly 400, except gas distribution plate assembly 500 includes non-fluidized particles 502, rather than plate 404. The use of non-fluidized particles allow one to more readily tune the pressure drop across the axial (vertical) direction of a bed and thus enable fluidization. Non-fluidized particles 502 can be formed of refractory material, such as zirconia, yttria, silicon nitride, or the like. An average cross-sectional dimension of non-fluidized particles 502 can be about 25 mm to about 1 mm or about 1 mm to about 0.03 mm. Active material 120 can reside on non-fluidized particles 502.

Returning to FIG. 1, gas inlet 110 can be coupled to one or more gas sources comprising a gas to be split. For example, gas inlet 110 can be coupled to a water and/or to a carbon dioxide source.

As illustrated, system 100 can include a heat source 128 to heat a gas prior to gas inlet 110. Heat source 128 can be or include any type of heater or heat exchanger, such as those described above in connection with heating element 122.

Gas outlet 112 can be coupled to one or more gas collection vessels. In accordance with examples of the disclosure, product gas from gas outlet 112 can be continually compressed and collected.

In accordance with the illustrated example, reactor 102 further includes (e.g., refractory) insulation material 116 and a (e.g., steel) pressure vessel 118. As illustrated, insulation material 116 can surround—e.g., encase reaction zone 104 and gas heating zone 106. Insulation material 116 can be or include, for example silica fire brick. Pressure vessel 118 can be formed of, for example, stainless steel or carbon steel. A thickness of a wall 130 of pressure vessel 118 can be between about 2 and about 5 mm or between about 5 and about 30 mm. Pressure vessel 118 can surround or encase insulation material 116, such that insulation material 116 is contained within a pressure vessel 118.

Controller 114 is configured to operate reaction zone 104 at a temperature as described above and to control a pressure within the reaction zone to greater than 1 bar during a gas splitting/oxidation step and less than or equal to 1 bar during an active material reduction step. As discussed in more detail below, controlling pressure within these regimes is thought to improve efficiency of thermochemical gas splitting reactor system 100.

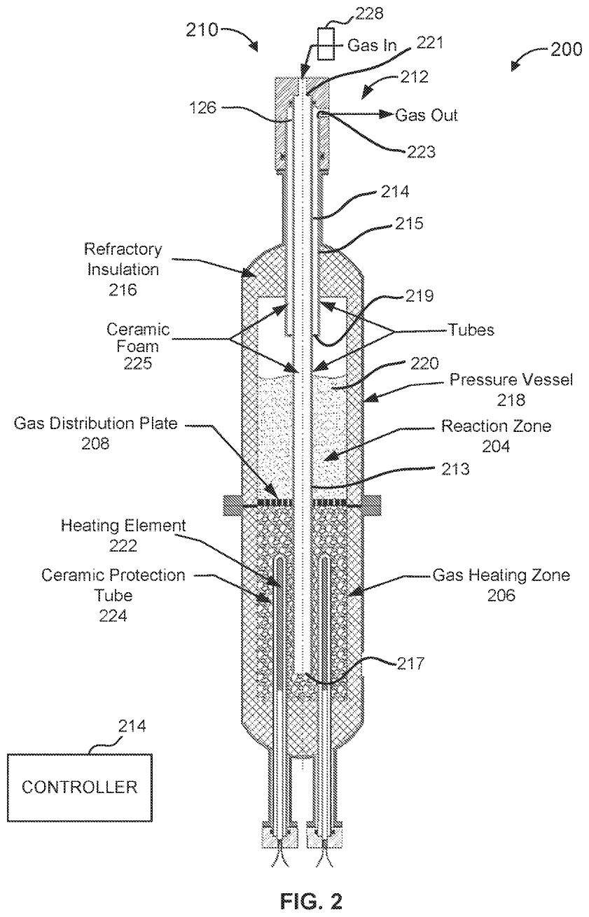

FIG. 2 illustrates another thermochemical gas splitting reactor system 200 in accordance with examples of the disclosure. Thermochemical gas splitting reactor system 200 is similar to thermochemical gas splitting reactor system 100, except that thermochemical gas splitting reactor system 200 uses a heat exchanger within system 200 to heat gas prior to entering a reaction zone.

In the illustrated example, thermochemical gas splitting reactor system 200 includes a reactor 202, which includes a reaction zone 204, a gas heating zone 206, and a gas distribution plate assembly 208 interposed between reaction zone 204 and the gas heating zone 206; a gas inlet 210 fluidly coupled to gas heating zone 206; a gas outlet 212 fluidly coupled to reaction zone 204; and a controller 214.

Reactor 202 can be similar to reactor 102 described above and can be configured to operate at the temperatures and pressures noted above. Similarly, reaction zone 204 and gas heating zone 206 can be similar to reaction zone 104 and gas heating zone 106 described above. Gas distribution plate 208 can be the same as gas distribution plate assembly 108.

In the illustrated example, gas inlet 210 and gas outlet 212 are at a same end of reactor 202 to allow for heat transfer from product gas that exits gas outlet 212 to gas received through gas inlet 210. By way of particular example, thermochemical gas splitting reactor system 200 includes a first tube 213 fluidly coupled to gas inlet 210 to transport gas received at gas inlet 210 to gas heating zone 206. Thermochemical gas splitting reactor system 200 also includes a tube 215 fluidly coupled to reaction zone 204 to receive product gas and transport the product gas to gas outlet 212.

Tubes 213, 215 can be formed of any suitable material. For example, tubes 213, 215 can be formed of a ceramic, such as alumina or silicon carbide. As illustrated, tubes 213, 215 can be substantially concentric, wherein a first end 217 of tube 213 extends beyond a first end 219 of second tube 215. A second end 221 of first tube 213 can also extend beyond a second end 223 of second tube 215. Tubes 213, 215 can be coated with or contain porous ceramic foam 225, which can be or include, for example, alumina or zirconia or silicon carbide.

Thermochemical gas splitting reactor system 200 can also include a controller 214, insulation material 216, a pressure vessel 218, material 220, heating element(s) 222, protective tube(s) 224 and optionally heat source 228, which can be the same or similar to controller 114, insulation material 116, pressure vessel 118, material 120, heating element(s) 122, protective tube(s) 124 and heat source 128 described above.

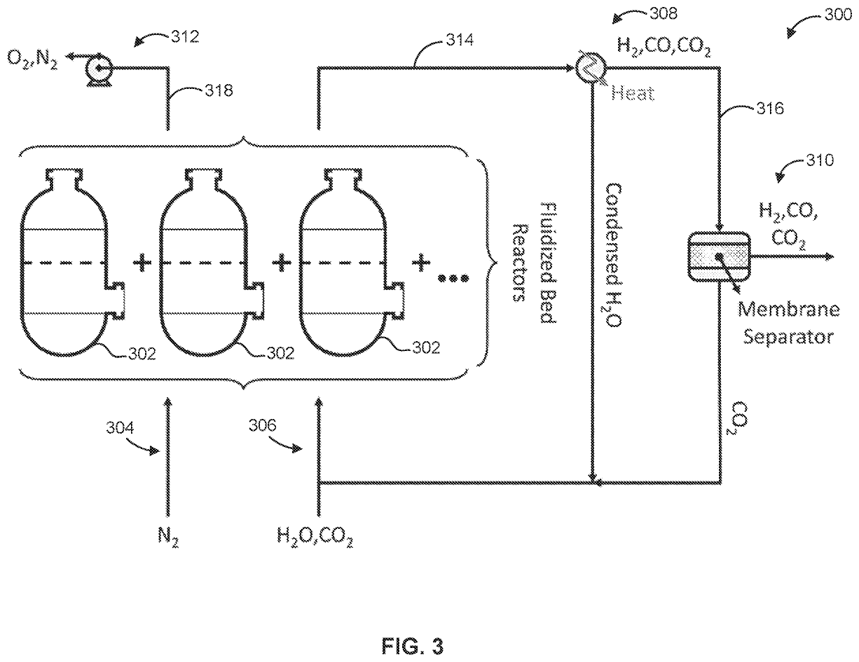

FIG. 3 illustrates a system 300 that includes a plurality of reactors 302, which can be the same or similar to thermochemical gas splitting reactor systems 100, 200 described above. Reactors 302 can operate alternatively and reversibly operate in a reduction mode and in an oxidation mode to allow for continuous capture of product gas from system 300. As illustrated, system 300 includes an inert gas (e.g., N₂) input 304, a reactant gas (e.g., H₂O and/or CO₂) input 306, a heat exchanger 308, a membrane separator 310, a compressor 312, and circulation lines 314, 316. During operation, oxidation products can be separated using membrane separator 310, and CO₂ can be circulated back to reactors 302. Similarly, reduction products can be circulated back to reactors 302 using line 318 and/or source 304.

In accordance with additional examples of the disclosure, a method is provided. Exemplary methods described herein can be used for thermochemical dissociation of water and/or carbon dioxide over a reduced metal oxide. Such reactions have long thought to be independent of total pressure, as the number of moles of gaseous reactants (i.e., H₂O and/or CO₂) and gaseous products (i.e., H₂ and/or CO) is equal. However, in accordance with aspects of exemplary embodiments, in an open system—where product gases are swept away from the reaction zone—operating at elevated pressures improves both the equilibrium extent and rate of the aforementioned equimolar oxidation reaction. This not only enables the use of more earth-abundant materials, but may also facilitate the production of green hydrogen (or syngas) that is both practical and efficient.

Thermochemical processes for the dissociation of H₂O (and/or CO₂) most commonly leverage alternating metal oxide (MOₓ) reduction-oxidation (redox) reactions to separate the production of O₂ and Hz (and/or CO) into distinct steps. The first step, which typically occurs at temperatures above 1400° C., involves the liberation of O₂ from the crystal lattice of a metal oxide:

$$\frac{1}{δ} {MO}_{x} \to \frac{1}{δ} {MO}_{x - δ} + \frac{1}{2} {O}_{2} {ΔH}_{298 K}^{∘} > 286 kJ {mol}^{- 1} \qquad 1 )$$

Then, at the same temperature or lower, an oxidant gas is introduced to produce the desired fuel and return (or oxidize) the oxygen-deficient (or reduced) metal oxide (MO_{x-δ}) back to its original state:

$$\begin{matrix}\frac{1}{δ} {MO}_{x - δ} + {H}_{2} O \to \frac{1}{δ} {MO}_{x} + {H}_{2}\end{matrix} \qquad 2 a )$$

$${ΔH}_{298 K}^{∘} < 0 kJ {mol}^{- 1}$$

$$\frac{1}{δ} {MO}_{x - δ} + {CO}_{2} \to \frac{1}{δ} {MO}_{x} + CO \qquad 2 b )$$

For brevity, Equations 1 and 2 describe a thermochemical cycle in which a binary metal oxide that accommodates oxygen vacancies, such as ceria (i.e., CeO_{2-δ}), is employed. It should be noted, however, that alternative nonstoichiometric materials exist, including materials that have recently been shown to accommodate cation vacancies.

For a candidate metal oxide, it is well established that the extent of reaction (δ) is dependent on both the operating temperature and oxygen partial pressure. Thus, to control material performance in the context of two-step thermochemical fuel production, the redox cycle can be implemented using a temperature swing and/or partial pressure swing. Considering the extremes, temperature-swing mode can greatly increase the thermochemical capacity of metal oxide for the production of fuel but suffers from practical limitations, namely significant heat losses and thermal stresses imposed by thermal cycling between redox regimes. Partial pressure-swing (or isothermal) mode, on the other hand, eliminates these concerns at the expense of restricting the capacity of the metal oxide to the difference in oxygen chemical potential between the high-temperature oxidant and the inert environment established during reduction; consequently, demonstrations considering the partial pressure-swing mode report lower oxidant conversion. As a result, a combination of both modes may be generally employed for prototype- or pilot-scale operation, where optimizing both the solar-to-fuel energy efficiency and oxidant conversion is prioritized.

To further reduce the oxygen partial pressure below what is otherwise achievable with only delivering air or an inert sweep gas, reduction (Equation 1), a non-equimolar reaction, is often performed under sub-ambient pressure. Conversely, oxidation (Equation 2), an equimolar reaction, has yet to be evaluated at pressures other than ambient, as according to Le Chatelier's principle, one would not expect any benefit from driving the reaction differently. Nevertheless, the produced fuel (i.e., hydrogen or syngas) is desirably supplied at elevated pressures for further processing. For example, hydrogen, due to its low volumetric energy density (i.e., 10 kJ L⁻¹), often requires compression at high pressures for storage, and downstream processes, such as Haber-Bosch or Fischer-Tropsch, inherently operate at high pressures (i.e., above 30 bar). Despite this universal understanding, solar-driven technologies for the production of hydrogen or syngas (from H₂O and/or CO₂), by conventionally operating at ambient pressure, largely neglect the work required for downstream compression when benchmarking performance (i.e., reporting solar-to-hydrogen or solar-to-fuel energy efficiencies). However, when considering the entire production chain for drop-in fuels (e.g., renewable kerosene) from sunlight, H₂O, and CO₂, it becomes evident that the energy penalty associated with downstream compression is, in fact, significant, accounting for up to 10% of the solar input in a recent pilot-scale demonstration where a two-step thermochemical cycle was employed. Importantly, such inefficiency may be abated by implementing the process (e.g., the oxidation step for two-step thermochemical fuel production) at an elevated pressure, as pressurizing a liquid reactant (i.e., H₂O) upstream is much more energy efficient (and more cost effective) than compressing a product gas (i.e., Hz) downstream. Furthermore, it is anticipated that sources of high-pressure CO₂ will be readily accessible in the near future, whether delivered via pipeline infrastructure or obtained from co-locating commercial plants with facilities capable of supplying CO₂ at high concentrations (e.g., direct air capture); thus, in such scenarios, the work required for product compression could be entirely avoided.

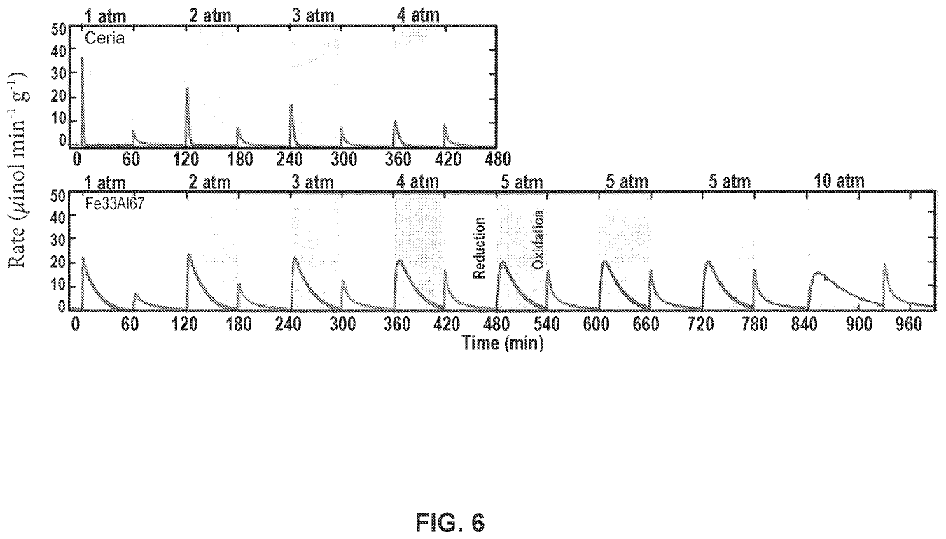

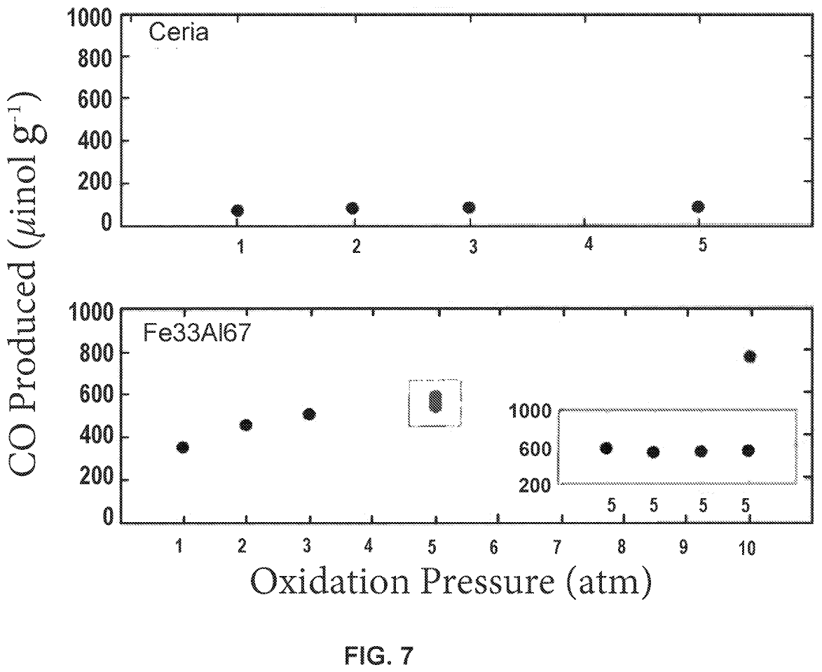

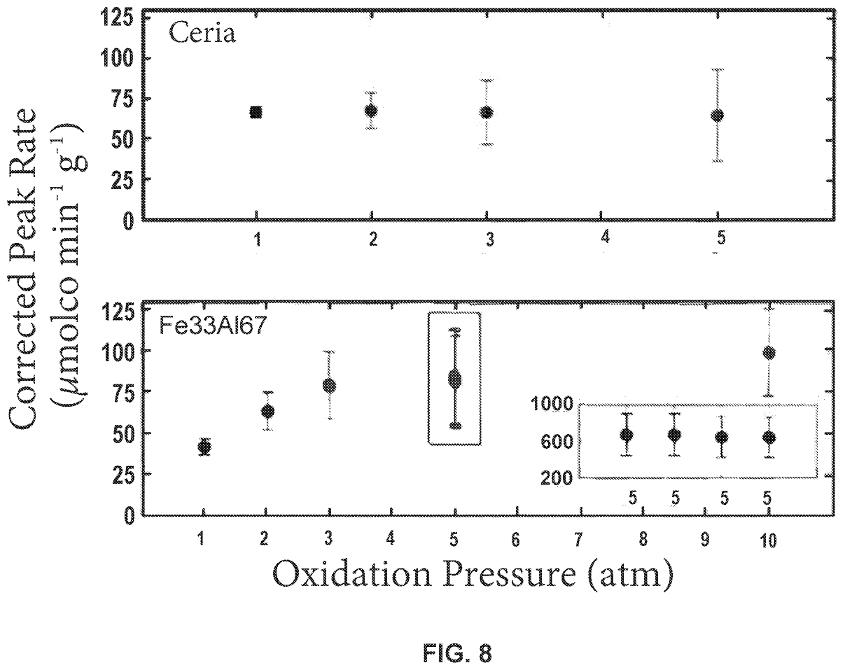

It has been surprisingly found that performing gas splitting or oxidation at greater than 1 bar leads to reduced energy requirements and reduced operating costs. Representative results using exemplary active materials are illustrated in FIG. 6 and Table 1. FIG. 7 illustrates cumulative amount of CO production in accordance with examples of the disclosure. FIG. 8 illustrates peak rate of production after accounting for the effects of gas-phase dispersion and mixing in accordance with examples of the disclosure.

TABLE 1
Further insight into material performance. Relevant metrics associated
with FIG. 6, namely, oxygen partial pressure (pO₂) and redox yields,
are quantified as a function of oxidant pressure.

| | Before | Oxidation: | | Reduction: |
|---|---|---|---|---|
| | Oxidation: | Pressure | CO Produced | O₂ Evolved |
| Material | Log₁₀(pO₂/atm) | (atm) | (μmol g⁻¹) | (μmol g⁻¹) |
| Ceria | −4.7 ± 0.01 | 1 | 71.1 ± 5.3 | 65.1 ± 0.6 |
| | | 2 | 83.0 ± 5.2 | 68.0 ± 0.6 |
| | | 3 | 83.3 ± 5.2 | 67.6 ± 0.6 |
| | | 5 | 83.2 ± 5.5 | 83.0 ± 0.7 |
| Fe33AI67 | −4.6 ± 0.01 | 1 | 356 ± 8.1 | 201 ± 1.0 |
| | | 2 | 460 ± 7.8 | 234 ± 1.1 |
| | | 3 | 510 ± 7.7 | 256 ± 1.2 |
| | | 5 | 588 ± 7.8 | 283 ± 1.2 |
| | | | 545 ± 7.7 | 282 ± 1.2 |
| | | | 552 ± 7.7 | 283 ± 1.2 |
| | | | 556 ± 7.7 | 281 ± 1.2 |
| | | 10 | 768 ± 9.9 | 381 ± 1.4 |

Notably, while ceria produced only slightly more CO at pressures beyond 1 atm, Fe33Al67 experienced a much greater effect, producing over 100% more CO when exposed to CO₂ at 10 atm than when exposed to CO₂ at 1 atm (i.e., 768±9.9 μmol g⁻¹ and 356±8.1 μmol g⁻¹, respectively). In fact, the demonstration of nearly 770 μmol g⁻¹ of CO represents among the highest (if not the highest) reported capacities for the production of fuel from a nonstoichiometric metal oxide under isothermal conditions and even exceeds that of promising perovskite and poly-cation oxide alternatives following temperature swings of several hundred degrees. Despite such different responses to changes in oxidant pressure, each improvement in fuel yield (i.e., oxidation extent) was accompanied by an increase in the rate of subsequent reduction, resulting in additional oxygen evolution considering the extents of reduction were kept consistent. Thus, for Fe33Al67, the molar ratio of fuel (i.e., CO) produced to oxygen evolved remained near 2:1 (see Equations 1 and 2), with cycle values ranging from 1.8±0.1:1 to 2.1±0.1:1; the molar ratios for ceria, on the other hand, were lower, ranging from 1.0±0.1:1 to 1.2±0.1:1. Here, deviations from the ideal 2:1 value are primarily attributed to the presence of thermolysis-derived oxygen at the transition from oxidation to reduction, confounding—in particular—the response of ceria given its relatively small capacity under the considered isothermal conditions. Another artefact, namely, axial dispersion and mixing in the gas phase (downstream of the reaction site), is responsible for the apparent broadening of the kinetic profiles. Once resolved, the intrinsic rate of CO production for Fe33Al67, in accordance with the yield, was found to increase with increasing oxidant pressure. Importantly, the thermodynamic and kinetic benefits of increasing oxidant pressure were repeatable, as shown with four consecutive iron aluminate-based cycles in which the reduction and oxidation steps were alternated between 1 and 5 atm, respectively.

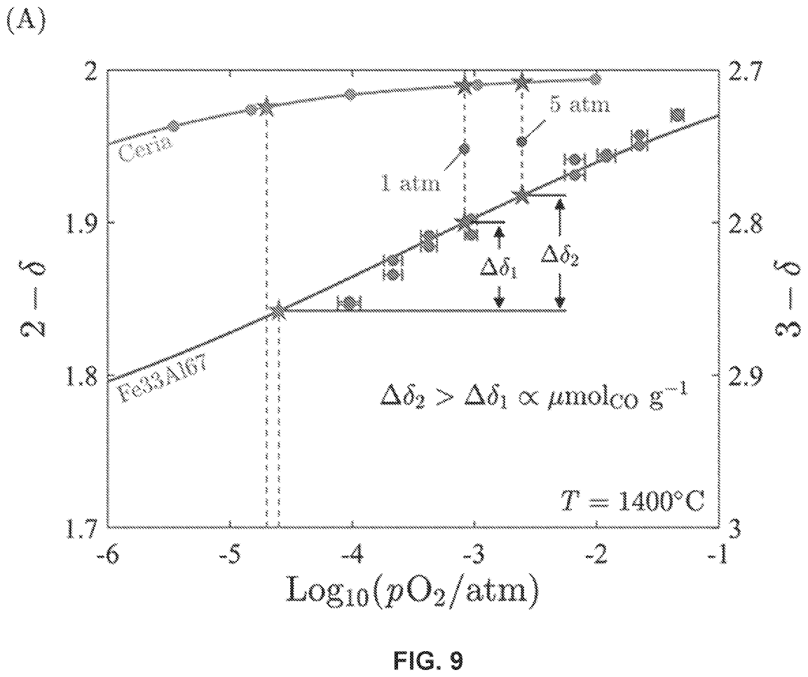

Experimental results were further corroborated using relevant excerpts from well-established equilibrium maps, which—as shown in FIG. 9—allow for the thermochemical capacity of an oxide (Δδ) to be quantified for a given set of thermodynamic states. For convenience, such states are often defined with respect to temperature and oxygen partial pressure, the latter of which can be either measured or calculated. Here, the oxygen partial pressure of the reduction step was determined by directly measuring the oxygen content in the effluent near reaction completion (see Table 1). The oxygen partial pressure of the oxidation step, on the other hand, was determined according to the equilibrium of, in this case, carbon dioxide thermolysis (i.e., CO₂→CO+½O₂), which is dependent on both temperature and pressure. With each thermodynamic state defined, it can be seen that, at 1400° C., Fe33Al67 is capable of much greater changes in the extent of reaction than that of ceria; ceria, in contrast, possesses a much higher standard partial molar enthalpy of reduction (i.e., above 400 KJ molₒ⁻¹) and, as a result, primarily tends to its fully oxidized state (i.e., δ=0) throughout the same range of conditions. Therefore, not only is the capacity of the iron aluminate much greater under the conventional partial pressure-swing mode (i.e., P=1 atm), but if the oxygen partial pressure of the inlet oxidant were to increase further, such as when the oxidation step is implemented at elevated pressures (e.g., P=5 atm), a more noticeable improvement in material performance would also be observed. Here, the ability to even access such higher oxygen partial pressures is attributed to the use of an open system reactor configuration, as by effectively sweeping the gaseous products (and their influence) away from the reaction site, each material was thus exposed to the pressure-dependent chemical potential of the delivered oxidant.

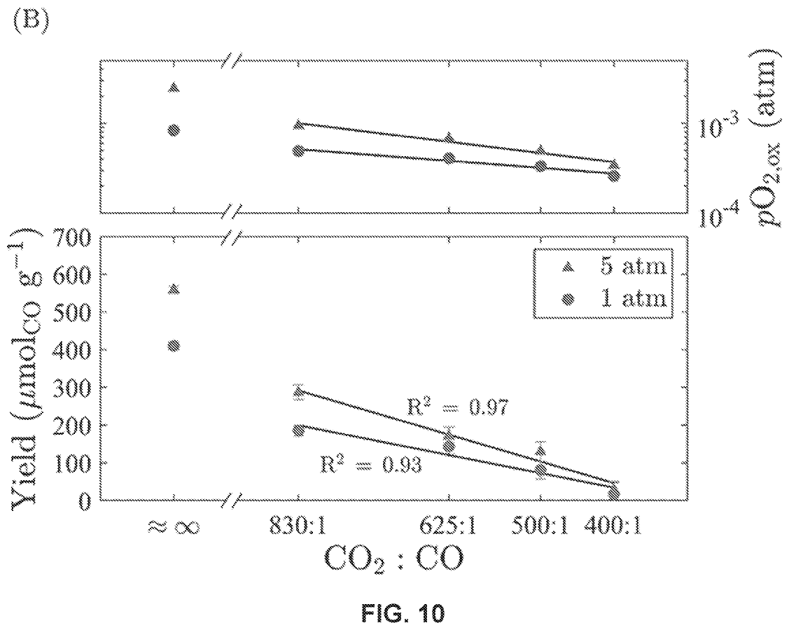

To further this understanding, additional experiments were performed with the iron aluminate to evaluate whether the aforementioned observations extend to conditions more representative of commercial practice, where the goal of maximizing the oxidant conversion implies that some of the active material will interact with oxidant diluted with products (i.e., H₂ and/or CO) produced elsewhere; the results of the campaign are presented in FIG. 10. As expected, upon exposure to less oxidizing gas mixtures (i.e., CO₂:CO<<∞), the extent of Fe33Al67 oxidation decreased, resulting in lower yields. By increasing the oxidant pressure from 1 to 5 atm, however, a portion of the reduced yields was able to be recovered, a consequence of establishing a higher oxygen partial pressure at the reaction site like before. As more CO (i.e., lower CO₂:CO ratios) is introduced though, the difference between the oxygen partial pressure that can be achieved during oxidation at 1 atm and, in this case, 5 atm, decreases, and thus the magnitude of the observed improvement concomitantly decreased. Importantly, this reduction in capacity can be compensated for either by further increasing oxidant pressure or by considering materials, such as Fe47Al53, which exhibit greater changes in 8 per unit change in oxygen partial pressure. In any case, it is evident that, in addition to temperature, total pressure can be exploited as a means to improve the extent of oxidation and, consequently, the oxidant conversion. Therefore, candidate materials (e.g., lanthanum manganite-based perovskites) or operating modes (e.g., partial pressure swing) previously rejected on the basis of demonstrating insufficient conversion may be suitable for use with systems and methods described herein.

By way of particular examples, a method in accordance with this disclosure includes providing a reactor comprising a reaction, such as a reactor (or system) described herein, providing one or more of H₂O and CO₂ to a gas heating zone or the reactor, heating the one or more of H₂O and CO₂ in the gas heating zone, providing heated one or more of H₂O and CO₂ through the gas distribution plate assembly and to the reaction zone, and splitting the heated one or more of H₂O and CO₂ in the reaction zone, wherein a temperature within the reaction zone is greater than about 1000° C. (e.g., a temperature range as provide herein) and pressure within the reaction zone is greater than 1 bar or between greater than 1 bar and about 10 bar or between 10 bar and 35 bar. The method can further include performing an active material reduction step in the reactor and/or in another reactor within a reactor system. A pressure within the reaction zone during the reduction step can be less than or equal to 1 bar or between 1 bar and 1 mbar.

During the exemplary method, product gas can be continually removed from the reaction zone during the step of splitting. In accordance with some exemplary aspects, the step of splitting and the reduction step are substantially isothermal (e.g., are performed substantially isothermally as described above). In other cases, the temperature can vary—as noted above.

The method can also include heating reactant gas prior to entering the gas heating zone. In such cases, the step of heating can include concentrating solar radiation heat, using (e.g., an array of) resistive heaters, and/or recuperating heat from a gas exhausted from the reactor.

The example embodiments of the disclosure described above do not limit the scope of the invention, since these embodiments are merely examples of the embodiments of the invention. Any equivalent embodiments are intended to be within the scope of this invention. Indeed, various modifications of the disclosure, in addition to the embodiments shown and described herein, such as alternative useful combinations of the elements described, may become apparent to those skilled in the art from the description. Such modifications and embodiments are also intended to fall within the scope of the appended claims.

1. A thermochemical gas splitting reactor system comprising:
a reactor comprising:
a reaction zone comprising active material;
a gas heating zone; and
a gas distribution plate assembly interposed between the reaction zone and the gas heating zone;
a gas inlet fluidly coupled to the gas heating zone;
a gas outlet fluidly coupled to the reaction zone; and
a controller configured to operate the reaction zone at a temperature greater than about 1000° C. and to control a pressure within the reaction zone to greater than 1 bar during a gas splitting step and less than or equal to 1 bar during an active material reduction step.

2. The thermochemical gas splitting reactor system of claim 1, wherein the reactor comprises insulation material contained within a pressure vessel.

3. The thermochemical gas splitting reactor system of claim 1, wherein the gas distribution plate assembly comprises one or more ceramic structures comprising alumina, zirconia, and/or silica.

4. The thermochemical gas splitting reactor system of claim 1, wherein the gas distribution plate assembly comprises a plurality of holes having a cross-sectional diameter between about 2.5 mm and about 0.5 mm and/or between about 200 microns and about 1 micron.

5. The thermochemical gas splitting reactor system of claim 1, further comprising a concentrated solar radiation heater, wherein a gas before entering the gas heating zone is preheated using the concentrated solar radiation heater.

6. The thermochemical gas splitting reactor system of claim 1, further comprising an array of resistive heaters, wherein a gas within the gas heating zone is heated using the resistive heaters.

7. The thermochemical gas splitting reactor system of claim 1, further comprising a heat exchanger, wherein a gas within the gas heating zone is preheated using the heat exchanger.

8. The thermochemical gas splitting reactor system of claim 7, wherein the heat exchanger removes heat from a product gas that is removed from the reactor via the gas outlet.

9. The thermochemical gas splitting reactor system of claim 1, wherein the active material comprises a metal oxide.

10. The thermochemical gas splitting reactor system of claim 9, wherein the active material comprises iron aluminate-based spinels, lanthanum-manganate-based perovskites, and/or ceria-based oxides.

11. The thermochemical gas splitting reactor system of claim 1, wherein the active material comprises (M_{ζ}Al_{1-ζ})_{3-δ}O₄, where ζ is greater than ⅓ and M is one or more of Fe, Co, Ti, Mn, Mg, Zn, Ni, and Cr.

12. A method of thermochemical gas splitting, the method comprising the steps of:
providing a reactor comprising a reaction zone comprising active material, a gas heating zone, and a gas distribution plate assembly interposed between the reaction zone and the gas heating zone;
providing one or more of H₂O and CO₂ to the gas heating zone;
heating the one or more of H₂O and CO₂ in the gas heating zone;
providing heated one or more of H₂O and CO₂ through the gas distribution plate assembly and to the reaction zone; and
splitting the heated one or more of H₂O and CO₂ in the reaction zone,
wherein a temperature within the reaction zone is greater than about 1000° C. and pressure within the reaction zone is greater than 1 bar.

13. The method of claim 12, further comprising performing an active material reduction step.

14. The method of claim 13, wherein a pressure within the reaction zone during the reduction step is less than or equal to 1 bar.

15. The method of claim 12, wherein product gas is continually removed from the reaction zone during the step of splitting.

16. The method of claim 12, wherein the step of splitting and a reduction step are substantially isothermal.

17. The method of claim 12, wherein the step of heating comprises concentrating solar radiation heat.

18. The method of claim 12, wherein the step of heating comprises resistive heating.

19. The method of claim 12, wherein the step of heating comprises recuperating heat from a gas exhausted from the reactor.
